(19) United States
(12) Patent Application Publication
(10) Pub. No.: US 2014/0244062 A1
(43) Pub. Date: Aug. 28, 2014

(54) METHOD AND CONTROL UNIT FOR REDUCING THE POWER CONSUMPTION IN AN ELECTRICAL SUPPLY NETWORK

(71) Applicants: Thomas BAUMANN, Kornwestheim (DE); Udo SCHULZ, Vaihingen/Enz (DE)

(72) Inventors: Thomas BAUMANN, Kornwestheim (DE); Udo SCHULZ, Vaihingen/Enz (DE)

(73) Assignee: ROBERT BOSCH GMBH, Stuttgart (DE)

(21) Appl. No.: 14/183,207

(22) Filed: Feb. 18, 2014

(30) Foreign Application Priority Data
Feb. 22, 2013 (DE) 10 2013 202 983.7

(51) Int. Cl. G05B 15/02

(52) U.S. Cl. CPC G05B 15/02
USPC 700/297

(57) ABSTRACT

A method for reducing the power consumption in an electrical supply network, sensors and at least one control unit in which program sequences are provided for operating the sensors being supplied with electrical energy from the electrical supply network. It is provided that sensors that are not operationally ready or whose measurement data are currently not required or whose measurement data are temporarily not evaluable, and/or program sequences assigned to these sensors, are temporarily deactivated. A control unit for carrying out the method are also described. The method and the control unit make it possible to reduce the power consumption in an electrical supply network.

### CROSS REFERENCE

The present application claims the benefit under 35 U.S.C. §119 of German Patent Application No. DE 10 2013 202 983.7 filed on Feb. 22, 2013, which is expressly incorporated herein by reference in its entirety.

### FIELD

The present invention relates to a method for reducing the power consumption in an electrical supply network, sensors and at least one control unit in which program sequences are provided for the operation of the sensors being supplied with electrical energy from the electrical supply network.

In addition, the present invention relates to a control unit for reducing the power consumption in an electrical supply network, the control unit being connected to sensors that are supplied with electrical energy from the electrical supply network or by the control unit, the control unit containing program sequences for operating the sensors, and the control unit being connected to the electrical supply network for the supply of energy.

### BACKGROUND INFORMATION

Electrical components supplied by an electrical supply network consume energy that has to be correspondingly provided by a power source. This is also true for active electrical components whose function is not required at the moment.

Therefore, for example for electrical supply networks of motor vehicles driven by internal combustion engines, it is conventional to temporarily shut off electric consumers that are not required, in order in this way to reduce the power consumption from the vehicle electrical system and thus to reduce fuel consumption and CO₂ emissions. The electrical energy of the vehicle electrical system is provided by a battery and by a generator driven by the internal combustion engine.

New designs for microcontrollers, such as multi-computer designs in control devices, enable the switching off or partial activation of individual processor cores, i.e. operation with a lower processor clock speed, which can save energy. For the switching off of entire control devices, sleep and wake-up designs are known. A precondition for the switching off and the partial activation of functions, for example during driving, is a precise knowledge of the system, and a knowledge derived therefrom of which functions in the system can be switched off or partially activated.

European Patent No. EP 0 601 300 B1 describes a vehicle having an internal combustion engine as a drive engine, sensors for acquiring vehicle speed on the one hand and operating states of the drive engine on the other hand, electric consumers that can be supplied with electrical energy from a vehicle battery and/or from a generator that can be driven by the drive engine, and that can be switched off, or whose energy requirement can be reset, when the internal combustion engine is switched off or restarted, and having a control device, connected to the sensors, for influencing the internal combustion engine and the electric consumers. Here it is provided that in the control device a plurality of different driving states, relating on the one hand to travel speed and vehicle standstill and to the respective operating state of the internal combustion engine for these states on the other hand, are each assigned specified types of consumers that, on the basis of the signals supplied by the sensors, corresponding to the respectively obtaining driving state, are switched off or reset individually or in groups, simultaneously or in succession, corresponding to an order of precedence stored in the control device.

European Patent No. 0 601 300 B1 describes a large number of consumers (headlight, front windshield wiper device, rear windshield heating unit, rear windshield wiper device, interior heating, seat heating, external mirror heating, engine ventilator, air-conditioning system, circulation pump, etc.) that are divided into corresponding classes (types) and are reset or switched off depending on the driving state and operating state. The switching off here takes place for example as a function of temperature values measured by temperature sensors.

German Patent Application No. DE 10 2006 026 404 A1 describes a method for managing electrical energy in an electric network, in particular a vehicle electrical system in which a plurality of electric consumers are connected, using an energy coordinator. Here it is provided that the energy coordinator monitors the occurrence of at least one specified operating state, and varies the power consumption of at least one of the consumers if a specified operating state has been determined.

In addition, the patent describes a device for carrying out the method. As consumers, an air conditioning compressor, an engine ventilator, an auxiliary heater, an electric power steering pump, or a DC/DC converter are named.

German Patent Application No. DE 10 2011 017 678 A1 describes an energy management method for an electrical energy storage device of a vehicle having consumers that can be connected at least temporarily via power interfaces, the consumers each being assigned a dynamically adapted power level, the adaptation of the provided power taking place dynamically as a function of a driving state of the vehicle and/or of an item of consumer information of the connected consumer.

Consumers in the sense of German Patent Application No. DE 10 2011 017 678 are so-called nomadic devices, such as mobile telephones, MP3 players, or navigation systems, generally having separate, integrated, chargeable accumulators. The energy management method outputs only as much power to nomadic devices connected via the power interfaces as is correspondingly appropriate to the current operating situation. For this purpose, for example the charge current supplied to a nomadic device is limited.

German Patent Application No. DE 10 2010 008 818 describes a method for activating at least one temporarily inactive network component of a network system for a vehicle, in particular a motor vehicle. Here it is provided that a central network device of the network system is connected in terms of signaling to the network component via a path within the network system, the path running at least partly via a network segment of the network system, and the network segment connecting, in terms of signaling, the network component and a first activation device assigned thereto in unbranched fashion to a switch device situated in the path and to a second activation device assigned thereto, and the central network device addressing the first activation device using the switch device, by sending a network function monitoring signal.

As a network component or network device, here a control device of a vehicle component, or at least of a part of such a control device, is provided that is temporarily deactivated in order to minimize the energy requirement of the vehicle.

In conventional devices and methods for reducing the power consumption in an electrical supply network, the energy consumption of the sensors themselves and of the associated program sequences for operating the sensors remains unaffected.

An object of the present invention is to provide a method with which the power consumption in an electrical supply network can be further reduced without negative influence on the desired functionality.

Furthermore, an object of the present invention is to provide a control unit suitable for this purpose.

### SUMMARY

In accordance with the present invention, the object of the present invention relating to the method may be achieved in that in the example embodiments, sensors that are not operationally ready or whose measurement data are currently not required or whose measurement data are temporarily not capable of being evaluated, and/or program sequences allocated to these sensors, are temporarily deactivated. Through the switching off of the sensors and of the associated program sequences, the energy supplied to the sensors is saved, and the energy consumption of the control units in which the program sequences are stored is reduced. Because the sensors are switched off only during operating phases in which their measurement data are not used, this takes place without limitation of the functionality of the system in which the sensors are situated. For this purpose, a correspondingly precise system knowledge is required in order to decide which sensors and which program sequences can currently be switched off.

The energy savings is advantageous in particular in battery-operated or battery-buffered systems.

Corresponding to a particularly preferred variant embodiment of the present invention, it can be provided that an internal combustion engine having sensors assigned to an exhaust gas aftertreatment system connected downstream from the internal combustion engine, which sensors are not operationally ready or whose measurement data are currently not required or whose measurement data cannot be evaluated in the current operating point of the internal combustion engine, and/or program sequences allocated to these sensors, are temporarily deactivated. A large number of different sensors are assigned to internal combustion engines and their exhaust gas aftertreatment systems, as used for example for driving motor vehicles. The sensors are used to measure pressures and temperatures, to determine the exhaust gas composition, or the like, and the measurement data are supplied to a control unit provided for the controlling of the internal combustion engine. In the control unit, corresponding program sequences are provided for the evaluation of the sensor data and for the controlling of the internal combustion engine. As a rule, the sensors are supplied electrically by the control unit, or directly by a battery. The battery, sensors, and control unit are integrated into the vehicle electrical system of the motor vehicle. The electrical energy is provided via a generator driven by the internal combustion engine, which, as an additional load, increases fuel consumption and thus CO₂ emissions.

Various sensor values are required only for particular operating points of the internal combustion engine, or are not evaluable for all operating points. According to an example embodiment of the present invention, these sensors and the associated software functions stored in the control unit can be deactivated or reactivated as needed. In this way, the consumption of electrical energy, and thus fuel consumption, is reduced, resulting in a reduction of the CO₂ emissions of the internal combustion engine. In addition, local areas of heating (so-called hotspots) in the control unit can be at least reduced. This results in less expensive cooling designs for the electronics.

If, during operating phases in which sensors are not operationally ready or in which they cannot be evaluated in the present operating point of the internal combustion engine, but the characteristic data determined by the sensors are nonetheless required for the operation of the internal combustion engine, it can be provided that sensor signals, or characteristic quantities derived from the sensor signals, are determined by a calculation model during the deactivation of the sensors or of the program sequences.

Due to required lower emission limits, in internal combustion engines, in particular diesel engines, exhaust gas aftertreatment systems having particle filters are used. In the particle filters, the soot that arises during operation of the internal combustion engine is collected.

Particle filters have a limited storage capacity, and have to be regenerated in order to renew their cleaning effect. For this purpose, through suitable interventions of the engine management system the exhaust gas temperature is increased until the deposited soot is burned. The regeneration is introduced when the particle loading of the particle filter exceeds a specified boundary value.

In order to monitor the particle loading of the particle filter, it is conventional to determine the pressure difference over the particle filter using a difference pressure sensor. From the pressure difference and the exhaust gas volume flow through the particle filter, a flow resistance of the particle filter can be determined as a quotient of the pressure difference and the exhaust gas volume flow. The flow resistance has a direct functional relationship to the state of loading of the particle filter, and can be used to evaluate it.

Given a partial loading of the internal combustion engine with a low exhaust gas volume flow, the differential pressure sensor over the particle filter supplies a low voltage signal, because the pressure drop over the particle filter is small. Due to the absolute tolerance of the difference pressure sensor, the difference pressure signal in the low-load region is highly susceptible to error, and is therefore not suitable for determining the state of loading of the particle filter.

During a regeneration of the particle filter, due to the exothermic processes during the burning of the particles the difference pressure over the particle filter fluctuates so strongly that in this operating state as well it is not possible to determine the soot loading of the particle filter using the difference pressure sensor.

When the internal combustion engine is switched off, for example in overrun operation or coasting, no combustion takes place and no particles are formed. Therefore, it is not necessary to determine the particle loading of the particle filter in these operational phases.

Therefore, in order to save energy in these phases, it can be provided that a difference pressure sensor situated over a particle filter situated in the exhaust gas aftertreatment system, and/or the program sequence associated with the difference pressure sensor, is deactivated at an operating point of the internal combustion engine having a low exhaust gas volume flow, or during a particle filter regeneration, or during stopping or coasting operation or an overrun phase of the internal combustion engine.

For the regeneration of the particle filter, precise temperature information about the exhaust gas is required. Therefore, as a rule, temperature sensors are provided before an oxidation catalytic converter situated in the exhaust gas aftertreatment system, and before the particle filter. From the temperature signal before the oxidation catalytic converter, the temperature difference due to the internal combustion engine is determined, while from the temperature signal before the particle filter the temperature difference due to combustion of fuel in the oxidation catalytic converter is determined. The temperature measurements are necessary because modeled exhaust gas temperatures during the regeneration phase of the particle filter are not sufficiently precise. However, outside the regeneration operating mode, the modeled exhaust gas temperature is sufficiently precise. Therefore, it can be provided that temperature sensors for monitoring the exhaust gas temperature during a regeneration of the particle filter, and/or the program sequences assigned to the temperature sensors, are switched off when no regeneration of the particle filter is carried out. If no regeneration is carried out, the modeled exhaust gas temperature is used.

An object of the present invention relating to the control unit is achieved in that the control unit contains a program sequence and hardware components for the purpose of temporarily deactivating sensors that are not operationally ready, or whose measurement data are not currently required, or whose measurement data are currently not evaluable, and/or for temporarily deactivating program sequences assigned to these sensors. The control unit thus enables the described method to be carried out.

Corresponding to a preferred variant embodiment of the present invention, it can be provided that the control unit is assigned to a motor vehicle having an internal combustion engine and an exhaust gas aftertreatment system, and that the sensors are provided in order to acquire characteristic quantities of the internal combustion engine and/or of the exhaust gas aftertreatment system and/or of the exhaust gas. The control unit and the sensors are provided with electrical energy by the vehicle electrical system of the motor vehicle, with a battery and a generator driven by the internal combustion engine. By switching off individual sensors and the associated software functions in the control unit, electrical energy, and thus the loading of the internal combustion engine by the generator, can be reduced, whereby the fuel consumption and the CO₂ emissions of the internal combustion engine can be reduced. The selection of which sensors can be switched off is a function of the current operating situation of, in particular, the internal combustion engine. The decision as to which sensors, and which associated program sequences, can be switched off presupposes a precise knowledge of the system, in particular of the internal combustion engine, the exhaust gas aftertreatment system, the control electronics, and the sensors.

### BRIEF DESCRIPTION OF THE DRAWINGS

Below, the present invention is explained in more detail on the basis of an exemplary embodiment shown in the Figure.

FIG. 1 shows the technical environment in which the present invention can be used, with the example of an internal combustion engine.

### DETAILED DESCRIPTION OF EXAMPLE OF EMBODIMENTS

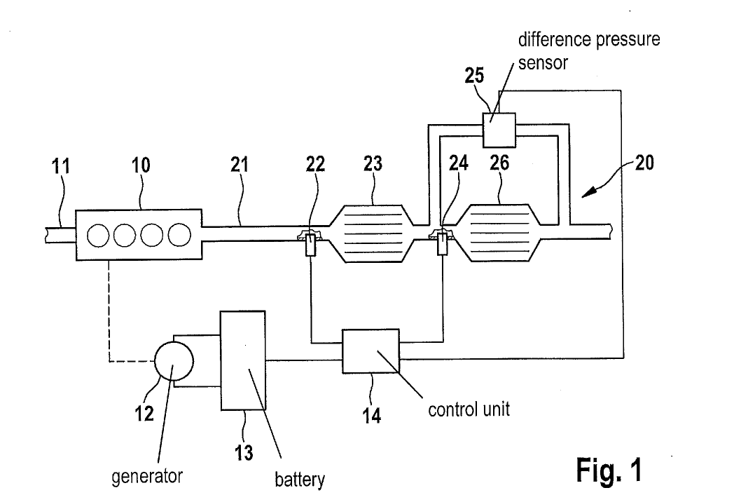

FIG. 1 shows, in a variant embodiment, the technical environment in which the present invention can be used, with the example of an internal combustion engine 10. The schematic representation shows internal combustion engine 10 having an exhaust gas aftertreatment system 20 and an air supply 11. The depiction is limited to the parts that are used for the description of the present invention.

Fresh air is supplied to internal combustion engine 10 via air supply 11.

The exhaust gas of internal combustion engine 10 is emitted to the surrounding environment via exhaust gas aftertreatment system 20. Exhaust gas aftertreatment system 20 contains an exhaust gas channel 21 in which the exhaust gas of internal combustion engine 10 is guided. In order to clean the exhaust gas, along the direction of flow of the exhaust gas there are situated an oxidation catalytic converter 23 and, subsequently, a particle filter 26. Oxidation catalytic converter 23 and particle filter 26 are realized as separate components, but can also be realized as an integrated constructive unit.

Parallel to particle filter 26 there is provided a difference pressure sensor 25 that is connected via a front connection to exhaust gas channel 21 before particle filter 26, and is connected with a rear connection to exhaust gas channel 21 after particle filter 26.

Before oxidation catalytic converter 23 there is situated a first temperature sensor 22, and before particle filter 26 there is situated a second temperature sensor 24.

Difference pressure sensor 25, first temperature sensor 22, and second temperature sensor 24 are electrically connected to a control unit 14. Their signals are read out by control unit 14, and they are supplied with electrical energy by control unit 14. Control unit 14 itself is supplied with power by a battery 13. Battery 13 is charged by a generator 12 driven by internal combustion engine 10.

In order to monitor the loading and the correct functioning of particle filter 26, difference pressure sensor 25 determines the pressure drop over particle filter 26. For this purpose, difference pressure sensor 25 is loaded at one side, via the front connection, with the exhaust gas pressure before particle filter 26, and is loaded on the other side, via the rear connection, with the exhaust gas pressure after particle filter 26. From the measured pressure difference over particle filter 26, and from the exhaust gas volume flowing through particle filter 26, control unit 14 calculates a flow resistance of particle filter 26 as the quotient of the pressure difference, relative to the exhaust gas volume flow. From the flow resistance, the loading of particle filter 26 can be determined, and when a loading limit is reached, a regeneration of particle filter 26 can be introduced. For this purpose, through suitable interventions by the engine management system the exhaust gas temperature is increased far enough that the deposited soot burns.

Given partial loading of internal combustion engine 10 with a low exhaust gas volume flow, difference pressure sensor 25 supplies a low voltage signal, because the pressure drop over particle filter 26 is low. Due to the absolute tolerance of difference pressure sensor 25, the relative error of the measured pressure difference in the case of partial load and low load of internal combustion engine 10 is very large. In these operating points, the measured pressure difference cannot be used for an adequately precise determination of the particle loading of particle filter 26. Therefore, in operating ranges with low exhaust gas volume flow, according to the present invention difference pressure sensor 25 is separated from the voltage supply, and the associated software function stored in control unit 13 is no longer calculated. In this way, the energy required for the operation of difference pressure sensor 25 is saved, and the energy requirement of control unit 13 is reduced. The saved energy no longer has to be applied via generator 12 of internal combustion engine 10, so that through this measure the fuel consumption of internal combustion engine 10, and thus also its emission of pollutants and CO₂, can be reduced.

During the phases in which difference pressure 25 is deactivated, the particle loading of particle filter 26 can be calculated using a corresponding calculation model, through integration of the raw soot emissions of internal combustion engine 10. The raw soot emissions can be determined from characteristic quantities such as injection pressure, injection quantity, injection pattern, the exhaust gas recirculation rate, engine rotational speed, engine torque, the lambda value of the exhaust gas, the charge pressure, and the temperature of internal combustion engine 10.

During the regeneration of particle filter 26, the pressure difference over particle filter 26 fluctuates very strongly due to the exothermic reactions during the burning process of the deposited particles. During the regeneration, the measured difference pressure therefore cannot be used to determine the loading of particle filter 26. Therefore, according to an example embodiment of the present invention, difference pressure sensor 25 and the associated program sequences can also be deactivated during the operating phase of the regeneration of particle filter 26.

In addition, difference pressure sensor 25 and the associated program sequences can be deactivated during operating phases of internal combustion engine 10 in which no combustion, and thus no entry of particles into particle filter 26, takes place. If internal combustion engine 10 is used in a motor vehicle, such operating phases can for example be present during coasting operation, when the internal combustion engine is decoupled and switched off, during overrun operation, or when the vehicle is at a standstill, for example at a traffic light.

During the regeneration of particle filter 26, precise temperature information about the exhaust gas is required. Therefore, first temperature sensor 22 is provided before oxidation catalytic converter 23 for determining the temperature difference due to internal combustion engine 10, and second temperature sensor 24 is provided in oxidation catalytic converter 23 for determining the temperature difference due to the combustion of fuel. When not in the regeneration operating mode, a modeled exhaust gas temperature is sufficiently precise. Therefore, in the regular operation of internal combustion engine 10, i.e., outside the regeneration operating phase, first temperature sensor 22 and second temperature sensor 24, as well as the associated program sequences stored in control unit 14, can be switched off, so that the energy supplied to them can be saved.

In addition to temperature sensors 22, 24 and difference pressure sensor 25 described in the exemplary embodiment, arbitrarily many further sensors not shown here that are allocated to internal combustion engine 10 or to exhaust gas aftertreatment system 20, and that are not operationally ready or whose measurement data are currently not required or whose measurement data are temporarily not evaluable, as well as their associated program sequences stored in control units, can be deactivated.

The procedure is not limited to internal combustion engines 10, but rather can be used for arbitrary electrical supply networks in which sensors are provided.

What is claimed is:

1. A method for reducing power consumption in an electrical supply network, sensors and at least one control unit in which program sequences are provided for operating the sensors supplied with electrical energy from the electrical supply network, the method comprising:
temporarily deactivating at least one of: i) sensors that are not operationally ready, ii) sensors whose measurement data are currently not required, iii) sensors whose measurement data are temporarily not evaluable, and iv) program sequences assigned to these sensors.

2. The method as recited in claim 1, wherein the temporarily deactivating step includes temporarily deactivating sensors, assigned to an internal combustion engine that has an exhaust gas aftertreatment system connected downstream from the internal combustion engine, that are at least one of: i) not operationally ready, ii) whose measurement data are currently not required, and iii) whose measurement data are not evaluable in the present operating point of the internal combustion engine.

3. The method as recited in claim 1, wherein the temporarily deactivating step includes temporarily deactivating program sequences of sensors that are at least one of: i) assigned to an internal combustion engine that has an exhaust gas aftertreatment system connected downstream from the internal combustion engine, ii) at least one of not operationally ready, iii) whose measurement data are currently not required, and iv) whose measurement data are not evaluable in the present operating point of the internal combustion engine.

4. The method as recited in claim 1, wherein, during the deactivation of the sensors or of the program sequences, sensor signals or characteristic quantities derived from the sensor signals are determined by a calculation model.

5. The method as recited in claim 2, wherein at least one of: i) a difference pressure sensor situated over a particle filter situated in the exhaust gas aftertreatment system, and ii) the program sequence assigned to the difference pressure sensor, is deactivated one of: i) during an operating point of the internal combustion engine having a low exhaust gas volume flow, ii) during a particle filter regeneration, or iii) during a stop or coasting operation or overrun phase of the internal combustion engine.

6. The method as recited in claim 2, wherein at least one of: temperature sensors for monitoring the exhaust gas temperature during a regeneration of the particle filter, and the program sequences associated with the temperature sensors, are switched off when no regeneration of the particle filter is carried out.

7. A control unit for reducing power consumption in an electrical supply network, the control unit being connected to sensors supplied with electrical energy from the electrical supply network or by the control unit, the control unit containing program sequences for the operation of the sensors, and the control unit being connected to the electrical supply network for energy supply, wherein the control unit contains a program sequence and hardware components to at least one of: i) temporarily deactivate sensors that are not operationally ready or whose measurement data are currently not required or whose measurement data are temporarily not evaluable, and ii) temporarily deactivate program sequences assigned to these sensors.

8. The control unit as recited in claim 7, wherein the control unit is assigned to a motor vehicle having an internal combustion engine and an exhaust gas aftertreatment system, and the sensors are provided for the acquisition of characteristic quantities of at least one of the internal combustion engine, the exhaust gas aftertreatment system, the exhaust gas.
